(19) United States
(12) Patent Application Publication
(10) Pub. No.: US 2013/0170812 A1
(43) Pub. Date: Jul. 4, 2013

(54) OPTICAL FIBER POSITIONING STRUCTURE

(71) Applicant: YU-CHAO HSIAO, Tu-Cheng (TW)

(72) Inventor: YU-CHAO HSIAO, Tu-Cheng (TW)

(21) Appl. No.: 13/661,413

(22) Filed: Oct. 26, 2012

(30) Foreign Application Priority Data
Dec. 29, 2011 (TW) 100149524

(51) Int. Cl. G02B 6/00

(52) U.S. Cl. 385/137

(57) ABSTRACT

An optical fiber positioning structure includes a first positioning member and a pair of second positioning members. The first positioning member includes a columnar shaped main body and a pair of latching portions extending from opposite side of the main body toward a same direction. Each second positioning member is columnar shaped, and the pair of second positioning members are clamped between the pair of latching potions and located below the first positioning member, such that a positioning space is bound by the pair of second positioning members and the main body for positioning an optical fiber.

### BACKGROUND

1. Technical Field

The present disclosure relates to a positioning structure, and more particularly, to an optical fiber positioning structure for fabricating an optical collimator.

2. Description of Related Art

An optical collimator is employed to transfer an optical signal into an electrical signal. The optical collimator includes an optical fiber and coupling lens. In order to fabricate the optical collimator, an optical fiber positioning structure is employed to align the optical fiber to the coupling lens. Such optical fiber positioning structure includes a base seat, a clamping member slidably mounted on the base seat, and three rotation buttons resisting on the clamping member. The clamping member is adjusted by the three rotation buttons, such that the clamping member moves in three-dimensional space to align the optical fiber to the couple lens. However, when the clamping member clamps the optical fiber unevenly, the optical fiber deviates from the axial line of the couple lens easily. In addition, it is inconvenient for an operator due to the employment of the three rotating buttons.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of a first embodiment of an optical fiber positioning structure when working.

FIG. 2 is a left view of the optical fiber positioning structure of FIG. 1.

FIG. 3 is a left view of a second embodiment of an optical fiber positioning structure when working.

### DETAILED DESCRIPTION

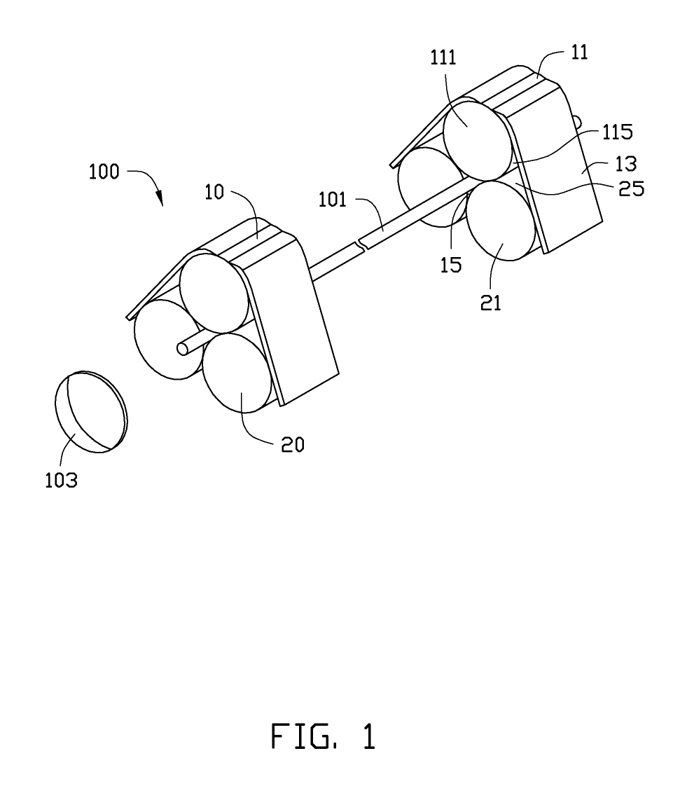

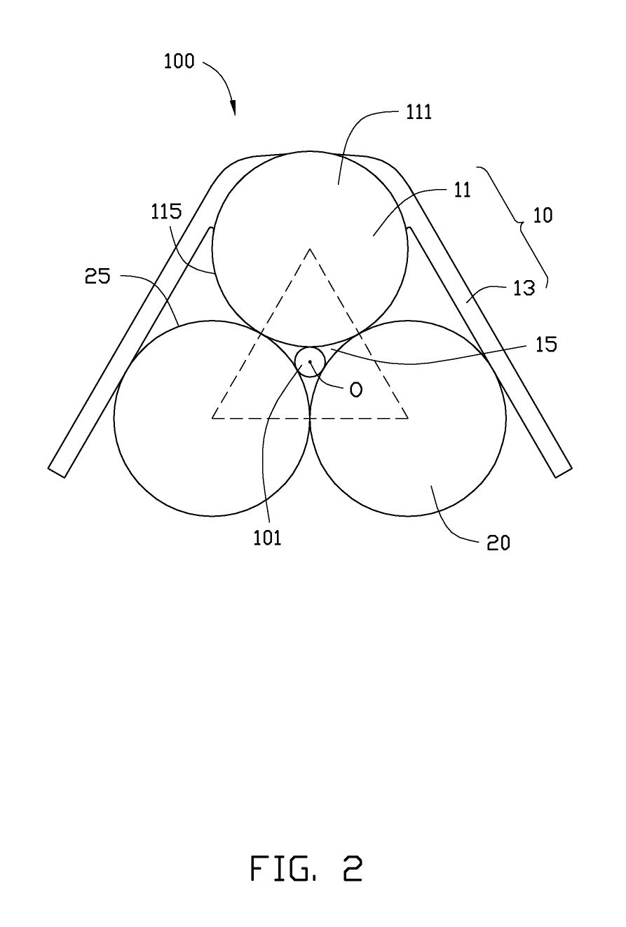

FIGS. 1 and 2 show a first embodiment of an optical fiber positioning structure 100 for aligning an optical fiber 101 to a couple lens 103. The optical fiber 101 should be coaxial with a coupling lens 103, and an end of the optical fiber 101 is positioned on the focus point of the coupling lens 103. The optical fiber positioning structure 100 includes a first positioning member 10 and a pair of second positioning members 20. The first positioning member 10 includes a main body 11 in a column shape and a pair of latching portions 13 extending along opposite sides of the main body 11 and defining an angle therebetween. The second positioning members 20 have column shapes. The pair of second positioning members 20 and the main body 11 are assembled in parallel together. The pair of second positioning members 20 is between the pair of latching potions 13 and located below the first positioning member 10, such that a positioning space 15 is cooperatively defined by the pair of second positioning members 20 and the main body 11.

The main body 11 defines a front end surface 111, a back end surface (not shown) opposite to the front end surface 111, and a periphery surface 115 surrounding a periphery of the main body 11. The front end surface 111 is parallel to the back end surface and both are planes. The periphery surface 115 perpendicularly connects with the front end surface 111 and the back end surface. The latching portion 13 is substantially a slab plate and extends along a tangential direction of the periphery surface 115 of the main body 11. The pair of latching portions 13 extends from a side of the main body 11 toward another side, and clamps the main body 11 and the pair of second positioning members 20. In the embodiment, an angle defined by the pair of latching portions 13 is about 60 degrees.

The pair of second positioning members 20 have the same structure as the main body 11. Each second positioning member 20 includes a front end surface 21, a back end surface (not shown) opposite to the front end surface 21, and a periphery surface 25 surrounding a periphery of the second positioning member 20.

The periphery surface 115 of the first positioning member 10 and the periphery surfaces 25 of the pair of second positioning members 20 tangentially abut each other and cooperatively form the positioning space 15. The front end surface 111 is coplanar with the front end surface 21, and the back end surface of the main body 11 is coplanar with the back end surfaces of the second positioning members 20. The pair of latching portions 13 respectively abuts against and adheres to the periphery surfaces 25 of the second positioning members 20. Referring to FIG. 2, connection lines of the central points of the three front end surfaces 111, 21, 21 form a triangle. The central point O of the triangle is located at the middle of an end of the positioning space 15. A diameter of the main body 11 is equal to that of the second positioning member 20. The triangle is substantially an equilateral triangle. In one embodiment, the pair of second positioning members 20 is made of plastic materials by ejection. The pair of second positioning members 20 may be fabricated one by one, and combined together.

When in use, the coupling lens 103 is fixed first. The pair of second positioning members 20 are set adjacent to the first coupling lens 103, a central line of the pair of second positioning members 20 has a same height with the focus point of the coupling lens 103. The optical fiber 101 is located on the joining portion of the pair of second positioning members 20. The first positioning member 10 is laid on the pair of second positioning members 20. The pair of latching portions 13 respectively clamp to outer sides of the periphery surfaces 25, such that the optical fiber 101 is secured by the first positioning member 10 and the pair of second positioning members 20. A periphery surface of the optical fiber 101 is bound by the periphery surfaces 115, 25. An end of the optical fiber 101 is exposed out of the positioning space 15 toward the couple lens 103. The optical fiber positioning structure 100 moves the optical fiber 101 until the optical fiber 101 is coaxial with the coupling lens 103, and the central point O of the triangle is located on the focus point of the coupling lens 103. The exposed portion of the optical fiber 101 from the positioning space 15 is cut off and an end surface of the optical fiber 101 is coplanar with the front end surfaces 111, 21, such that the optical fiber 101 is positioned. To clamp the optical fiber stably, two coaxially aligned optical fiber positioning structures 100 are employed to support the optical fiber 101, such that the optical fiber may not bend due to gravity.

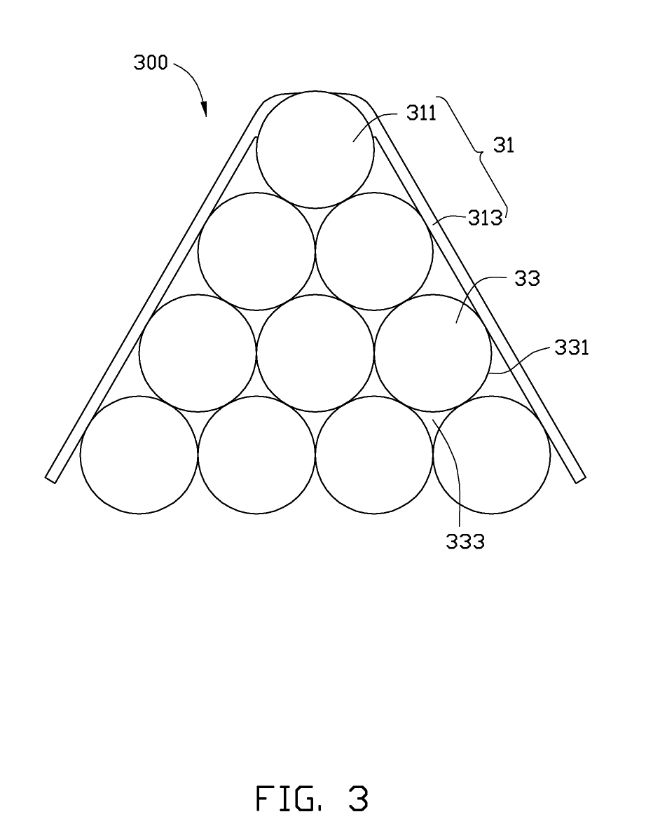

FIG. 3 shows a second embodiment of an optical fiber positioning structure 300 for positioning a plurality of optical fibers 101 to fabricate a multi-core optical collimator. The optical positioning structure 300 includes a first positioning member 31 and a plurality of second positioning members 33. The first positioning member 31 has a similar structure to the first positioning member 10. The first positioning member 31 includes a main body 311 in a column shape and a pair of latching portions 313 extending along opposite sides of the main body 11 defining an angle therebetween. A length of the latching portion 313 is greater than that of the latching portion 13. The second positioning members 31 have the same structure as the main body 311, such that the second positioning members 31 are a column post.

The difference between the optical fiber positioning structure 300 and the optical fiber positioning structure 100 is that the plurality of second positioning members 33 composes a laminated layer structure. Each layer comprises several second positioning members 33 substantially parallel to each other. Each second positioning member 33 abuts against one adjacent second positioning member 33 via a periphery surface 331 thereof. The number of the second positioning members 33 of a layer is one less than that of the next one lower layer. Three second positioning members 33 of adjacent two layers abuts each other via periphery surfaces 331 and cooperatively form a positioning space 333 receiving an optical fiber 101. The first positioning member 31 is located at a top layer of the plurality of second positioning members 33, the pair of latching members 313 enclose the plurality of second positioning members 33. A diameter of the main body 311 is equal to that of the second positioning member 33. An angle defined by the pair of latching portions 313 is about 60 degrees. The plurality of second positioning members 33 may be fabricated by ejection, or one by one and then fixed together.

The diameters of the first positioning member 10 and the second positioning member 20 may be changed according a diameter of the optical fiber 101, so that the optical fiber 101 is tightly clamped within the positioning space 15. The angle defined by the pair of latching portions 13 may be changed in need.

The pair of latching portions 13 may detachably abut the pair of second positioning members 20 respectively. The first positioning member 10 and the pair of second positioning members 20 may be formed by ejection, and when in use, the optical fiber 101 extends into the positioning space 15 from an end toward the coupling lens 103. The layer structure of the optical fiber positioning structure 100 may be changed according to the optical collimator.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. An optical fiber positioning structure, comprising:
a first positioning member comprising a columnar shaped main body and a pair of latching portions extending from opposite side of the main body toward a same direction, the pair of latching portions defining an angle therebetween; and
a pair of second positioning members, wherein each second positioning member is columnar shaped, and the pair of second positioning members are restricted between the pair of latching potions and located below the first positioning member, such that a positioning space is cooperatively defined by the pair of second positioning members and the main body for positioning an optical fiber.

2. The optical fiber positioning structure of claim 1, wherein a diameter of the main body is substantially equal to that of each of the second positioning members, and the pair of latching portions extend from the main body toward a side for receiving the pair of second positioning members.

3. The optical fiber positioning structure of claim 2, wherein each latching portion is substantially a slab plate and extends along a tangential direction of a periphery of the main body, and an angle defined by the pair of latching portions is about 60 degrees.

4. The optical fiber positioning structure of claim 3, wherein the main body defines a front end surface at an end and a periphery surface surrounding a periphery of the main body, each second positioning member defines a front end surface at an end and a periphery surface surrounding a periphery of the second positioning member, the front end surface of the main body is coplanar with the front end surfaces of the pair of second positioning members, and the positioning space is bounded by the periphery surfaces of the first positioning member and the pair of the second positioning members.

5. The optical fiber positioning structure of claim 4, wherein connection lines of central points of the front end surfaces of the main body and the pair of second position members form an equilateral triangle, and a central point of the equilateral triangle is located at the middle of an end of the positioning space.

6. The optical fiber positioning structure of claim 1, wherein a diameter of the main body is unequal to that of the pair of second positioning members, diameters of the pair of second positioning members are substantially the same, and the pair of latching portions tangentially abut against the pair of second positioning members

7. The optical fiber positioning structure of claim 1, wherein the pair of second positioning members are made from plastic materials by ejection, and the pair of latching portions are respectively adhered to the pair of positioning members.

8. An optical fiber positioning structure, comprising:
a first positioning member comprising a columnar shaped main body and a pair of latching portions extending from opposite sides of the main body toward a same direction, the pair of latching portions defining an angle therebetween; and
a plurality of second positioning members divided into a plurality of layers, wherein each second positioning member is columnar shaped, the plurality of second positioning members are restricted between the pair of latching potions and located below the first positioning member, and three second positioning members of two adjacent layers abut each other and cooperatively define a positioning space for positioning an optical fiber.

9. The optical fiber positioning structure of claim 8, wherein a diameter of the main body is substantially equal to that of each second positioning member, and the pair of latching portions extend from the main body toward a side to receive the plurality of second positioning members.

10. The optical fiber positioning structure of claim 9, wherein each latching portion is substantially a slab plate and extends along a tangential direction of a periphery of the main body, the number of the second positioning members of a layer is one less than that of the next one lower layer, and the angle defined by the pair of latching portions is about 60 degrees.

11. The optical fiber positioning structure of claim 10, wherein the main body defines a front end surface at an end and a periphery surface surrounding a periphery of the main body, each second positioning member defines a front end surface at an end and a periphery surface surrounding a periphery of the second positioning member, and the front end surface of the main body is coplanar with the front end surfaces of the plurality of the second positioning members.

12. The optical fiber positioning structure of claim 11, wherein one positioning space is bounded by the periphery surfaces of the first positioning member and two second positioning members, and periphery surfaces of three second positioning members of two adjacent layers cooperatively bounded one positioning space.

13. The optical fiber positioning structure of claim 11, wherein connection lines of central points of the front end surfaces of three second position members which abut against each other form an equilateral triangle, and a central point of the equilateral triangle is located at the middle of an end of the positioning space bounded by the three second positioning members.

14. The optical fiber positioning structure of claim 8, wherein a diameter of the main body is unequal to that of the plurality of second positioning members, diameters of the plurality of second positioning members are substantially the same, and the pair of latching portions tangentially abut against the plurality of second positioning members from an outer side.

15. The optical fiber positioning structure of claim 8, wherein the plurality of second positioning members are made from plastic materials by ejection, and the pair of latching portions are respectively adhered to the pair of positioning members.
